(19) United States
(12) Patent Application Publication
(10) Pub. No.: US 2010/0088920 A1
(43) Pub. Date: Apr. 15, 2010

(54) Harvest drying method and apparatus

(76) Inventor: Albert M. LaRou, Naperville, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/287,539

(22) Filed: Oct. 10, 2008

(51) Int. Cl. F26B 3/34; F26B 19/00; F26B 25/00; F26B 3/00

(52) U.S. Cl. 34/255; 34/68; 34/86; 34/236; 34/469

(57) ABSTRACT

A multi-stage harvest dryer (10) is provided for drying an agricultural harvest product (12), such as, for example, corn, sunflowers, beans, seeds, etc. The dryer (10) includes multiple drying stages (14a-14d) connected in sequence to dry a volume of harvest product (12) passed from one drying stage (14) to the next. Heat exchangers (16a, 16b, 18a, 18b, 18c) are located in the stages (14a-14c) to transfer heat to the harvest product (12) in each of the corresponding stages (14a-14d). The heat exchangers (16a and 16b) are radiant heat exchangers that efficiently heat the harvest product (12) via radiant heat transfer, with heaters (19a, 19b) being provided to maintain the heat exchangers (16a, 16b) within a desired temperature range. The heat exchangers (18a-18c) are condensers that efficiently recycle the heat within the dryer (10) by transferring heat back to the harvest product (12) by condensing water that has been evaporated from the harvest product (12) elsewhere in the dryer (10).

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to the drying of grain and other agricultural harvest products.

### BACKGROUND OF THE INVENTION

The thermo-mechanical drying of harvest products such as seeds, grains, and beans is common and provides many advantages. For example, the U.S.A. corn harvest in recent years has exceeded ten billion bushels. Corn, if harvested when considered ripe and under normal weather conditions, may contain 25 or 26% moisture and must be dried to no more than 15½% moisture before shipment or storage to avoid spoiling. While drying costs may be avoided or reduced by leaving the corn to stand in the field for natural drying to occur, this exposes the corn to possible weather damage by wind and rain, or insects that may significantly reduce the yield. Furthermore, the ideal time to harvest may also depend upon the ripeness vs. price received at the grain elevator. Thus, thermo-mechanical dryers are commonly used to prepare the product for shipment or storage.

The drying process is typically a grower cost that is driven primarily from the use of electrical fans that direct hot air through the corn mass for drying and fossil fuel such as propane, natural gas, or fuel oil, used to heat the air. The hot air with its initial ambient moisture, the product of combustion (carbon compounds) for the fossil fuel, and the moisture extracted from the corn is then expelled into the atmosphere. This process typically has 25%-28% fixed cost plus variable cost of 65%-69% per acre.

Since vaporization of water is dependent upon the heat (BTU) required to change from liquid to vapor gas plus the heat (BTU) required to raise the temperature of the grain, the air movement acts as a medium to transfer fossil generated heat to the grain for convection heat transfer. The amount of vapor generated is proportional to the amount of heat entering each kernel of grain.

Corn at 25% moisture, contains 709 lbs. of water per 100 bushels, which must be heated by contact with the hot air, evaporated and exhausted. The traditional hot air drying process described above is energy intensive with poor thermal transfer from air to corn, requiring high energy consumption. In addition, loose particles and dust not discharged to the atmosphere must be removed before storage in silos to reduce the possibility of explosions or spontaneous combustion. Such discharge can also be unacceptable for the control of genetically modified field grown corn since it creates undesirable pollution of the surrounding process area.

### SUMMARY OF THE INVENTION

In accordance with one feature of the invention, a multi-stage harvest dryer is provided for drying an agricultural harvest product. The dryer includes multiple drying stages connected in sequence to dry a volume of harvest product passed from one drying stage to the next, and at least one heat exchanger located in at least one of the stages to transfer heat to the harvest product in the at least one of the stages.

As one feature, the at least one heat exchanger includes a radiant heat exchanger in the form of a radiant heat wall surface defining a drying chamber for one of the stages. As a further feature, the at least one heat exchanger further includes another heat exchanger in the form of a condenser in one of the stages connected to receive water evaporated from the harvest product elsewhere in the dryer and located to transfer heat from the evaporated water to the harvest product. As yet a further feature, the condenser is located in the drying chamber. In one feature, the at least one heat exchanger includes another heat exchanger in the form of another radiant heat wall surface defining a drying chamber for another one of the stages. As another feature, the at least one heat exchanger further includes another heat exchanger in the form of another condenser in the another one of the stages connected to receive water evaporated from the harvest product elsewhere in the dryer and located to transfer heat from the evaporated water to the harvest product in the another one of the stages.

According to another feature, the multi-stage harvest dryer further includes a hot water generating fuel cell connected to the radiant heat wall surface to supply water generated by the fuel cell to the radiant heat wall surface to transfer heat from the water to the radiant heat wall surface. As a further feature, the multi-stage harvest further includes another fuel cell connected to the hot water cell to supply Hydrogen and Oxygen thereto.

In one feature, the radiant heat wall surface has a black surface finish facing the chamber.

As one feature, the multi-stage harvest dryer further includes a mechanical harvest product mover located in the at least one of the stages to circulate harvest product relative to the at least one heat exchanger.

In accordance with one feature of the invention, a multi-stage harvest dryer is provided for drying an agricultural harvest product. The dryer includes a first radiant heat wall surface defining a first drying volume or chamber for the harvest product, a first heater located to transmit heat to the first radiant heat wall surface to maintain the wall surface within a desired temperature range, a second radiant heat wall surface defining a second drying chamber for the harvest product; and a second heater located to transmit heat to the second radiant heat wall surface to maintain the second radiant heat wall surface within a desired temperature range. The second drying volume is located downstream from the first drying volume to receive harvest product therefrom.

As one feature, the multi-stage harvest dryer further includes a condenser connected to receive water evaporated from the harvest product elsewhere in the dryer. The condenser is located to transfer heat from the evaporated water to the harvest product in one of the drying chambers.

In one feature, each of the heaters is provided in the form of a water jacket surrounding the corresponding radiant heat wall surface to transfer heat from a hot water flow to the radiant heat wall surface. As a further feature, the multi-stage harvest dryer further includes at least one hot water generating fuel cell connected to the water jacket to supply the hot water flow thereto. In yet a further feature, the multi-stage harvest dryer further includes at least one other fuel cell connected to the at least one hot water generating fuel cell to supply hydrogen and oxygen thereto. As an additional feature, the at least one other fuel cell is connected to the water jacket to receive a cooled water flow therefrom to utilize in the generation of hydrogen and oxygen.

According to one feature, the multi-stage harvest dryer further includes a mechanical harvest product mover located in each of the drying chambers to circulate harvest product relative to the radiant heat wall surfaces.

In accordance with one feature of the invention, a multi-stage harvest dryer is provided for drying an agricultural harvest product. The dryer includes a first condenser in one of the stages connected to receive water evaporated from the harvest product in another of the stages, and located to transfer heat from the evaporated water to the harvest product in the one of the stages; and a second condenser in another one of the stages connected to receive water evaporated from the harvest product in another of the stages, and located to transfer heat from the evaporated water to the harvest product in the another one of the stages.

As one feature, the first condenser is connected to the another one of the stages to receive water evaporated from the harvest product heated by the second condenser.

In one feature, the multi-stage harvest dryer further includes a header connected the condensers to the header to direct the evaporated water thereto.

According to one feature, the multi-stage harvest dryer further includes a hot water generating fuel cell connected to at least one of the stages to supply water for heating the harvest product in the at least one of the stages, and a second fuel cell connected to the hot water generating fuel cell to supply hydrogen and oxygen thereto, at least one of the condensers connected to the second fuel cell to supply condensed water thereto for the generation of hydrogen and oxygen.

As another feature, the multi-stage harvest dryer further includes a hot water generating fuel cell connected to at least one of the stages to supply water for heating the harvest product in the at least one of the stages, and a second fuel cell connected to the hot water generating fuel cell to supply hydrogen and then oxygen thereto. The at least one of the stages is connected to the fuel cell to supply the water thereto for the generation of hydrogen and oxygen after the water has been cooled in the at least one of the stages.

In accordance to one feature of the invention, a method is provided for drying agricultural harvest product. The method includes the steps of heating harvest product to evaporate water therefrom, collecting the evaporated water; condensing the evaporated water by transferring heat therefrom to harvest product that has not yet undergone the heating step.

According to one feature, the heating step includes radiant heat transfer to the harvest product. In an additional feature, the heating step includes generating hot water from a fuel cell and heating a radiant heat surface with the hot water. As yet a further feature, the method further includes the step of supplying water from the condensing step to a fuel cell to generate hydrogen and oxygen therefrom.

As one feature, the method further includes the step of supplying water from the heating step to a fuel cell to generate hydrogen and oxygen therefrom.

As one feature, the heating step includes condensing water evaporated from the harvest product during another step of the method.

In one feature, the heating and condensing steps occur at the same time.

In accordance with one feature of the invention, a method is provided for drying agricultural harvest product. The method includes the steps of heating harvest product via radiant heat transfer from a surface surrounding the harvest product in a first stage, transferring the harvest product to a second stage, and heating harvest product via radiant heat transfer from a surface surrounding the harvest product in the second stage.

According to one feature, the method further includes the steps of collecting water evaporated from the harvest product in the second stage, and condensing the evaporated water by transferring heat therefrom to harvest product in the first stage.

As one feature, each of the heating steps includes generating hot water from a fuel cell and heating a radiant heat surface with the hot water.

As one feature, the method further includes the step of supplying water from the heating step to a fuel cell to generate hydrogen and oxygen therefrom.

In one feature, harvest product is heated in the first stage while harvest product is being heated in the second stage.

According to one feature, each of the heating steps includes circulating the harvest product relative to the surface.

Other objects, features, and advantages of the invention will become apparent from a review of the entire specification, including the appended claims and drawings.

### BRIEF DESCRIPTION OF THE DRAWINGS

FIG. 1 is a diagrammatic representation of a multi-stage harvest dryer embodying the present invention;

FIG. 2 is a somewhat diagrammatic representation showing preferred embodiments of the multi-stage harvest dryer of FIG. 1;

FIG. 3 is a somewhat diagrammatic representation of a fuel cell system employed in the embodiment of FIG. 2; and

FIG. 4 is a view taken from line 4-4 in FIG. 2 illustrating a further preferred embodiment for the stages of the multi-stage harvest dryer.

### DETAILED DESCRIPTION OF THE PREFERRED EMBODIMENT

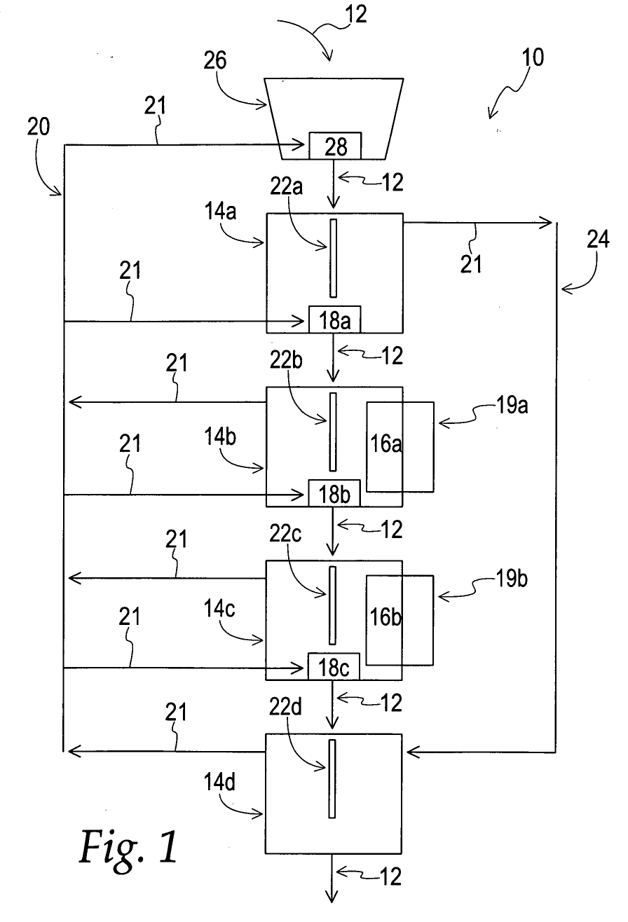

With reference to FIG. 1, a multi-stage harvest dryer 10 is shown for drying an agricultural harvest product 12, such as, for example, corn, sunflowers, beans, seeds, etc. The dryer 10 includes multiple drying stages 14a-14d connected in sequence to dry a volume of harvest product 12 passed from one drying stage 14 to the next. Heat exchangers 16a, 16b, 18a, 18b and 18c are located in the stages 14a-14c to transfer heat to the harvest product 12 in each of the corresponding stages 14a-14c. The heat exchangers 16a and 16b are radiant heat exchangers that efficiently heat the harvest product 12 via radiant heat transfer, with heaters 19a and 19b being provided to maintain the heat exchangers 16a and 16b within a desired temperature range, which in one preferred embodiment is 175° F. to 205° F. The heat exchangers 18a-18c are condensers that efficiently recycle the heat within the system by transferring heat back to the harvest product 12 by condensing water that has been evaporated from the harvest product 12 elsewhere in the system 10.

Preferably, a header 20 is connected to each of the stages 14a-14d to collect evaporated water 21 from the harvest product 12 and to supply the evaporated water 21 to each of the heat exchangers 18a-18c. In this regard, it should be noted that air will be admitted in the dryer 10 when the harvest product 12 is initially loaded into the dryer 10. This air is collected together with the evaporated water 21 by the header 20. Furthermore, to assist in the heating and drying of the harvest product 12, a mechanical harvest product mover 22a-22d is preferably provided in each of the stages 14a-14d to circulate the harvest product 12 within the stage 14 and relative to the heat exchangers 16a-16b and 18a-18c. It is also preferred that the evaporated water 21 from the harvest product 12 in stage 14a also be collected and transferred to stage 14d, as shown by flow path 24.

Optionally, but preferred, a hopper 26 with an additional heat exchanger 28 can be provided upstream of the stage 14a to preheat the harvest product 12 before it is loaded into the stage 14a. In this regard, it is also preferred that the heat exchanger 28 be provided in the form of a condenser that is also connected to the header 20 to receive evaporated water 21 and transfer the heat from the evaporated water 21 to the harvest product 12 within the hopper 26 while condensing the evaporated water 21.

One preferred operation of the dryer 10 can be described as a “batch” operation and can best be explained in terms of an operating sequence for a single volume or “batch” of the harvest product 12 as it is passed sequentially through the stages 14a-14d of the system 10. Initially, the volume of harvest product 12 is preheated in the hopper 26 by the heat exchanger 28 utilizing evaporated water 21 that has been gathered from another volume of harvest product 12 in stage 14d. After preheating, the volume of harvest product 12 is transferred to the stage 14a to be sequentially dried. Water evaporated from volumes of harvest product 12 in each of stages 14b and 14d is collected by the header 20 and supplied to the heat exchanger 18a wherein it is condensed via heat transfer to the volume of harvest product 12 in stage 14a. The partially dried volume of harvest product 12 heated in stage 14a is then transferred to stage 14b wherein the volume of harvest product 12 is heated via radiant heat transfer from the heat exchanger 16a and by the condenser 18b which transfers heat from the evaporated water 21 supplied via the header 20 after being collected from volumes of harvesting product 12 in stages 14c and 14d. The partially dried volume of harvest product 12 is then transferred to stage 14c wherein it is heated by the radiant heat exchanger 16b and the condenser 18b which transfers heat from evaporated water 21 supplied via the header 20 after being collected from the harvest product 12 in stage 14d. At this point, the volume of harvest product 12 is at its highest temperature and extensively dried and is transferred to stage 14d wherein residual heat in the harvest product 12 continues to evaporate some of the water from the harvest product 12 as the harvest product 12 cools. In this regard, the evaporated water 21 and air mixture directed from stage 14a into stage 14d via the flow path 24 assists in cooling the harvest product 12 in stage 14d because the evaporated water 21 and air mixture from stage 14a is cooler than the harvest product 12 which enters stage 14d at its highest temperature in the process. After the volume of harvest product 12 is processed in stage 14d, it can be discharged from the dryer 10 for shipment and/or storage.

Under one scenario for this type of “batch” operation, the dryer 10 can supply 1000 bushels of corn per hour, with each volume or “batch” of harvest product 12 being equal to 200 bushels and processed in each or the stages 14a-14d for 10 minutes, with the harvest product 12 undergoing a temperature rise in the range of 10° to 15° F. in each of the stages 14a-14d and the hopper 26, and having its percent moisture content reduced by approximately 3 percentage points in stage 14a, 2.5 percentage points in stage 14b, 1.8 percentage points in stage 14c and approximately 4 percentage points during the cooling in stage 14d.

In another mode of operation, a continuous flow of the harvest product 12 can be provided by allowing a limited continuous flow of the harvest product 12 into and out of each of the stages 14a-14d. In this “continuous” operation, the gates 66a-66e are fixed at an intermediate opening size that allows a fixed flow rate of the harvest product 12 (based on a percentage of the harvest product 12 in each stage 14) to flow to the next stage 14. The intermediate opening size can be automatically modulated by computer servo controls based on the temperatures of the product 12 in each stage 14. It is believed the continuous flow mode of operation can achieve a 20% increase in output in comparison to “batch” flow mode operation.

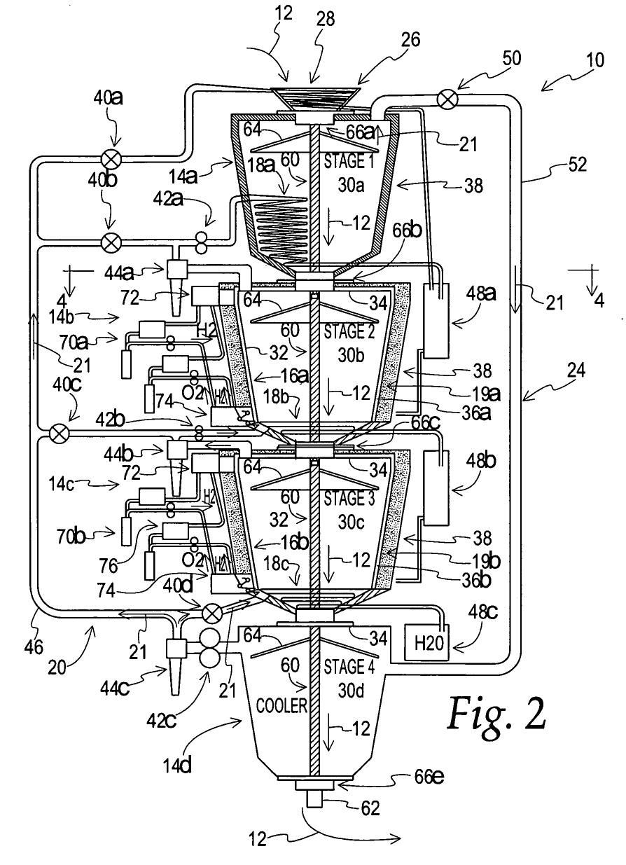

With reference to FIG. 2, a somewhat diagrammatic representation of a highly preferred embodiment of the dryer 10 is shown. In this embodiment, each of the stages 14a-14d includes a drying chamber 30a-30d having a cone shape that converges in a vertically downward direction. Each of the radiant heat exchangers 16a and 16b is provided in the form of a radiant heat side wall surface 32 that defines the sides of the corresponding drying chamber 30b, 30c and an upper radiant heat wall surface 34 that defines the upper extent of the corresponding drying chamber 30a and 30b. While any suitable service finish can be used, it is preferred that each of the wall surfaces 32 and 34 has a high radiant energy emissivity black surface finish that also has low friction/nonstick properties. The heaters 19a, 19b are provided in the form of water jackets 36a and 36b that surround the wall surfaces 32 and 34 in each of the stages 14b, 14c to direct a hot water flow in heat transfer relation with exterior sides of the wall surfaces 32 and 34. While any suitable material can be used, it is preferred that the wall surfaces 32 and 34 and the water jackets 36a, 36b be formed from stainless steel.

The condensers 18a-18c can be of any suitable type that will efficiently transfer heat from the evaporated water 21 to the harvest product 12 within each of the chambers 30a-30c. In this regard, the condenser 18a are shown in the form of a typical coiled-tube type condenser located in the lower half of chamber 30a, while the condensers 18b and 18c are shown as hairpin tube type constructions located in the bottom of their respective chambers 30b and 30c.

Suitable insulation 38 is provided around each of the drying chambers 30a-30c, and is preferably of sufficient thickness to prevent significant temperature losses from the chambers 30a-30c.

The header 20 is provided in the form of a header system that includes suitable flow control valves 40a-40d, vapor pumps 42a-42c, and cyclone separators 44a-44c that are all connected using suitable conduits or pipes 46. The cyclone separators 44a-44c remove small particles and dust from the evaporated water 21 and the air entrained therein as it is collected by the header 20. After it is condensed in the condensers 16a-16c and 28, the water is preferably directed to water tanks 48a-48c where air that has been entrained with the water can be separated for discharge by a low pressure relief valve. Preferably, the flow path 24 includes a flow control valve 50 that is connected by suitable conduits or pipes 52 to the stages 14a and 14d.

The mechanical harvest product movers 22a-22d are provided in the form of vertical grain augers 60 that can either be commonly driven by a single motor 62, or independently driven by individual motors (not shown). It is also preferred that each of the stages 14a-14d include a cone-shaped diverter 64 adjacent the upper end of each of the augers 60 where the harvest product 12 is discharged from the auger 60. The diverters 64 direct the harvest product 12 under the force of gravity past the upper surfaces 34 and towards the wall surfaces 32 to assist in the circulation of the harvest product 12 and improve the radiant heat transfer from the surfaces 34 and 32. In this regard, it should be noted that, in addition to radiant heat transfer, heat will also be transferred to the harvest product 12 via direct contact with the wall surface 32 and via convection from the heated atmosphere within each of the chambers 30a-30d.

Control gates 66a-66e are provided at the entrance and exit of each of the chambers 30a-30d to control the flow of harvest product 12 into and out of each of the stages 14a-14d. While any suitable gate can be utilized, it is preferred that each of the control gates 66 be an electrically powered aperture gate that can be either manually or automatically controlled.

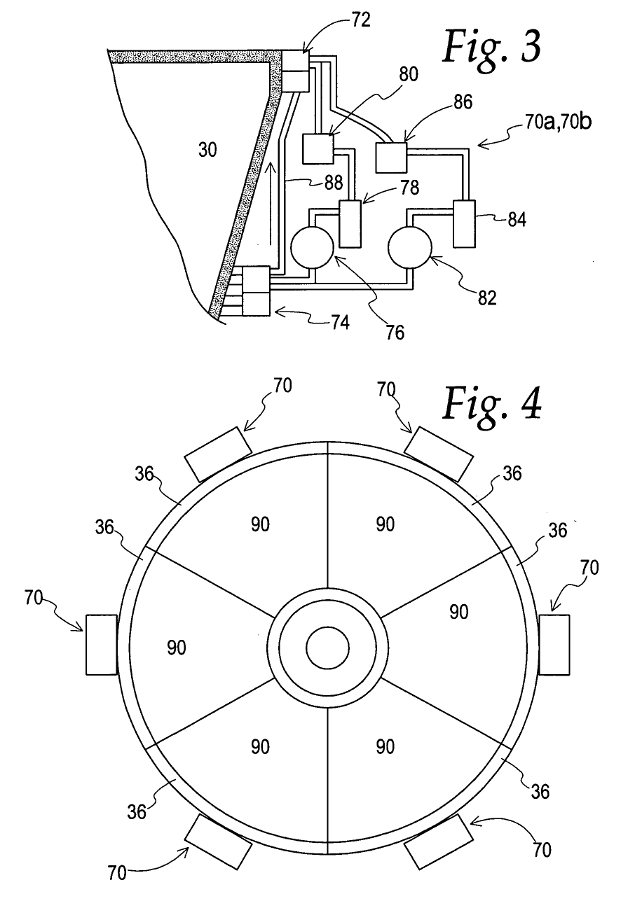

The stages 14b and 14c include respective fuel cell systems 70a and 70b that provide the hot water to the respective water jackets 36a, 36b. Each of the fuel cell systems 70a, 70b includes a hot water generating fuel cell stack 72 that generates the hot water for the corresponding water jacket by converting hydrogen (H₂) and oxygen (O₂) to high temperature water and DC electric power, and a hydrogen/oxygen generating fuel cell stack 74 that converts DC electric power and cooled water from the jacket 36a, 36b into H₂ and O₂ which can then be supplied to the fuel cell stack 72 to generate the high temperature water during drying operations. In this regard, as best seen in FIG. 3, each of the systems 70a, 70b further includes a H₂ pump 76 that directs H₂ into a pressurized H₂ storage container 78 which can then be selectively supplied to the fuel cell stack 72 via a flow control valve 80, and an O₂ pump 82 that directs O₂ to a pressurized O₂ storage container 84 selectively supplied to the fuel cell stack 72 via a flow control valve 86. It should be understood that inefficiencies in the fuel cell stacks 72 and 74 will require a certain amount of “make-up” water to be supplied to the fuel cell stack 74 under some conditions. This “make-up” water can be supplied on an as needed basis from any, or all, of the water tanks 48a-48c which is particularly suitable for use in the fuel cell stack 74 because the water is deionized water as a result of the evaporation process by which it has been generated. With reference to FIG. 3, a flow line 88 can optionally be provided to bypass the fuel cell stacks 74 and direct cooled water from the water jackets 36a, 36b to the fuel cell stacks 72 to cool the fuel cell stacks 72, preferably via a heat exchanger provided within the stacks 72. This is advantageous for certain types of fuel cell stacks 72 that operate at very elevated temperatures and/or generate hot water at very elevated temperatures. Any suitable type and construction, many of which are known, can be utilized for the components 72-84 of the fuel cell system 70a, 70b. The temperature of the high temperature water supplied to the water jackets 36a, 36b can be modulated within the desired temperature range by the control valves 80 and 86.

Preferably all of the control valves, motors, pumps, and gates, of the dryer 10 can be controlled automatically via a suitable computer control and are powered via the same DC electric power source as used to power the fuel cells 74a and 74b, which is preferably provided in the form of one or more suitable DC storage batteries (not shown) that can receive energy from any source of electric power to supplement the DC electric power that the batteries will receive from the fuel cells 72a, 72b. In this regard, preferred power sources for the batteries include wind turbines or solar panels supplying low voltage DC current, however, AC power may also be used with converters to charge the batteries and with frequency modulation for various blower speeds. It should be understood that in the preferred embodiment, the DC electric power generated by the fuel cells 72a, 72b will be sufficient to power all of the other components of the dryer 10 except for supplemental power required for the heaters 19a and 19b during normal operating conditions of the dryer 10.

Calculations have shown that the dryer 10 of FIG. 1 can provide an 80% reduction in the energy required to provide an equivalent amount of harvest product 12 from a conventional hot air type dryer system. This can largely be attributed to the efficient heating provided by the radiant heat exchangers 16a and 16b in combination with the efficient recycling of heat provided by the condensers 18a-18c and 28 together with the header 20.

As best seen in FIG. 4, in one preferred embodiment, each of the stages 14a-14d can be provided in the form of six pre-assembled 60° segments 90, with each segment 90 having one of the fuel systems 70 attached thereto to feed an independent water jacket 36 for the stages 14b and 14c. The segments 90 are assembled tightly together and sealed to form the drying chamber 30 for each stage 14.

It should be appreciated that because of the relatively low power requirements for the dryer 10, “green” energy sources such as wind turbines and solar panels can be used to power the dryer 10, thereby eliminating any need to utilize fossil fuels in the drying of the harvest product 12. Furthermore, it should be appreciated that because the dryer 10 can operate as a closed system, the dryer 10 can completely contain the product 12 and provide zero or near zero emissions of particles and dust. Furthermore, it should be appreciated that because of the controlled manner in which the harvest product 12 is heated within the dryer 10, with max temperatures being maintained within a desired range for the heat exchangers 16a and 16b, undesirable nutrient modification can be reduced in the harvest product 12 in comparison to conventional dryers. Furthermore, it is believed that shell cracking can be reduced in the harvest product 12 because of relatively high humidity maintained in the early stages of the dryer 10. Finally, it should be noted that during time periods wherein the dryer 10 is not operating to dry harvest product 12, the deionized condensate water in the tank 48a-48c can be used to generate hydrogen and oxygen from the fuel cell 74, which can be stored and made available later as alternate emission free fuel for operation of engines fueled by hydrogen to drive other machines, such as product elevators, conveyors, tractor equipment, and other vehicles and equipment not associated with the drying operation. This is particularly advantageous when energy sources such as wind turbines and/or solar panels are used to power the fuel cell 74 because the wind and/or solar power will often be available during time periods when the dryer is not operating to dry harvest product 12.

It should be appreciated that while the dryer 10 has been described herein as including four stages 14a-14d, in some applications it may be desirable to utilize more or fewer than four stages. For example, in some applications it may be desirable to utilize only two stages 14, while in other applications it may be desirable to utilize five or more stages. Similarly, while the radiant heat exchangers 16 are utilized in just two of the stages 14 in the illustrated embodiments, in some applications it may be desirable to utilize a radiant heat exchanger 16 in each of the stages of the dryer 10, or in only one of the stages of the dryer 10. Furthermore, again depending upon the requirements of the application, it may be desirable to utilize the condensers 18 in more or fewer than the stages 14 described for the preferred embodiment shown herein.

1. A multi-stage harvest dryer for drying an agricultural harvest product, the dryer comprising:
multiple drying stages connected in sequence to dry a volume of harvest product passed from one drying stage to the next; and
at least one heat exchanger located in at least one of the stages to transfer heat to the harvest product in the at least one of the stages.

2. The multi-stage harvest dryer of claim 1 wherein the at least one heat exchanger comprises a heat exchanger in the form of a radiant heat wall surface defining a drying chamber for one of the stages.

3. The multi-stage harvest dryer of claim 2 wherein the at least one heat exchanger further comprises another heat exchanger in the form of a condenser in one of the stages connected to receive water evaporated from the harvest product elsewhere in the dryer and located to transfer heat from the evaporated water to the harvest product.

4. The multi-stage harvest dryer of claim 3 wherein the condenser is located in the drying chamber.

5. The multi-stage harvest dryer of claim 3 wherein the at least one heat exchanger comprises another heat exchanger in the form of another radiant heat wall surface defining a drying chamber for another one of the stages.

6. The multi-stage harvest dryer of claim 5 wherein the at least one heat exchanger further comprises another heat exchanger in the form of another condenser in the another one of the stages connected to receive water evaporated from the harvest product elsewhere in the dryer and located to transfer heat from the evaporated water to the harvest product in the another one of the stages.

7. The multi-stage harvest dryer of claim 2 further comprising a hot water generating fuel cell connected to the radiant heat wall surface to supply water generated by the fuel cell to the radiant heat wall surface to transfer heat from the water to the radiant heat wall surface.

8. The multi-stage harvest dryer of claim 7 further comprising another fuel cell connected to the hot water cell to supply Hydrogen and Oxygen thereto.

9. The multi-stage harvest dryer of claim 2 wherein the radiant heat wall surface has a black surface finish facing the chamber.

10. The multi-stage harvest dryer of claim 1 further comprising a mechanical harvest product mover located in the at least one of the stages to circulate harvest product relative to the at least one heat exchanger.

11. A multi-stage harvest dryer for drying an agricultural harvest product, the dryer comprising:
a first radiant heat wall surface defining a first drying chamber for the harvest product;
a first heater located to transmit heat to the first radiant heat wall surface to maintain the wall surface within a desired temperature range;
a second radiant heat wall surface defining a second drying volume for the harvest product; and
a second heater located to transmit heat to the second radiant heat wall surface to maintain the second radiant heat wall surface within a desired temperature range, the second drying volume located downstream from the first drying volume to receive harvest product therefrom.

12. The multi-stage harvest dryer of claim 11 further comprising a condenser connected to receive water evaporated from the harvest product elsewhere in the dryer, the condenser located to transfer heat from the evaporated water to the harvest product in one of the drying chambers.

13. The multi-stage harvest dryer of claim 11 wherein each of the heaters is in the form of a water jacket surrounding the corresponding radiant heat wall surface to transfer heat from a hot water flow to the radiant heat wall surface.

14. The multi-stage harvest dryer of claim 13 further comprising at least one hot water generating fuel cell connected to the water jacket to supply the hot water flow thereto.

15. The multi-stage harvest dryer of claim 14 further comprising at least one other fuel cell connected to the at least one hot water generating fuel cell to supply hydrogen and oxygen thereto.

16. The multi-stage harvest dryer of claim 15 wherein the at least one other fuel cell is connected to the water jacket to received a cooled water flow therefrom to utilize in the generation of hydrogen and oxygen.

17. The multi-stage harvest dryer of claim 11 further comprising a mechanical harvest product mover located in each of the drying chambers to circulate harvest product relative to the radiant heat wall surfaces.

18. A multi-stage harvest dryer for drying an agricultural harvest product, the dryer comprising:
a first condenser in one of the stages connected to receive water evaporated from the harvest product in another of the stages and located to transfer heat from the evaporated water to the harvest product in the one of the stages; and
a second condenser in another one of the stages connected to receive water evaporated from the harvest product in another of the stages and located to transfer heat from the evaporated water to the harvest product in the another one of the stages.

19. The multi-stage harvest dryer of claim 18 wherein the first condenser is connected to the another one of the stages to receive water evaporated from the harvest product heated by the second condenser.

20. The multi-stage harvest dryer of claim 18 further comprising a header connected to the condensers to direct the evaporated water thereto.

21. The multi-stage harvest dryer of claim 18 further comprising:
a hot water generating fuel cell connected to at least one of the stages to supply water for heating the harvest product in the at least one of the stages; and
a second fuel cell connected to the hot water generating fuel cell to supply hydrogen and oxygen thereto, at least one of the condensers connected to the second fuel cell to supply condensed water thereto for the generation of hydrogen and oxygen.

22. The multi-stage harvest dryer of claim 18 further comprising:
a hot water generating fuel cell connected to at least one of the stages to supply water for heating the harvest product in the at least one of the stages; and
a second fuel cell connected to the hot water generating fuel cell to supply hydrogen and oxygen thereto, the at least one of the stages connected to the fuel cell to supply the water thereto for the generation of hydrogen and oxygen after the water has been cooled in the at least one of the stages.

23. A method of drying agricultural harvest product, the method comprising the steps of:
heating harvest product to evaporate water therefrom;
collecting the evaporated water; and
condensing the evaporated water by transferring heat therefrom to harvest product that has not yet undergone the heating step.

24. The method of claim 23 wherein the heating step comprises radiant heat transfer to the harvest product.

25. The method of claim 24 wherein the heating step comprises generating hot water from a fuel cell and heating a radiant heat surface with the hot water.

26. The method of claim 25 further comprising the step of supplying water from the condensing step to a fuel cell to generate hydrogen and oxygen therefrom.

27. The method of claim 25 further comprising the step of supplying water from the heating step to a fuel cell to generate hydrogen and oxygen therefrom.

28. The method of claim 23 wherein the heating step comprises condensing water evaporated from the harvest product during another step of the method.

29. The method of claim 23 wherein the heating and condensing steps occur at the same time.

30. A method of drying agricultural harvest product, the method comprising the steps of:
heating harvest product via radiant heat transfer from a surface surrounding the harvest product in a first stage;
transferring the harvest product to a second stage; and
heating harvest product via radiant heat transfer from a surface surrounding the harvest product in the second stage.

31. The method of claim 30 further comprising the steps of:
collecting water evaporated from the harvest product in the second stage; and
condensing the evaporated water by transferring heat therefrom to harvest product in the first stage.

32. The method of claim 30 wherein each of the heating steps comprises generating hot water-from a fuel cell and heating a radiant heat surface with the hot water.

33. The method of claim 32 further comprising the step of supplying water from the heating step to a fuel cell to generate hydrogen and oxygen therefrom.

34. The method of claim 30 wherein harvest product is heated in the first stage while harvest product is being heated in the second stage.

35. The method of claim 30 wherein each of the heating steps comprises circulating the harvest product relative to the surface.
